(19) United States
(12) Patent Application Publication
(10) Pub. No.: US 2007/0129273 A1
(43) Pub. Date: Jun. 7, 2007

(54) In situ fluoride ion-generating compositions and uses thereof

(76) Inventors: Philip G. Clark, Eden Prairie, MN (US); Nobuaki Ando, Sagamihara-shi (JP); Paul E. Rajtar, Hugo, MN (US)

Correspondence Address: 3M INNOVATIVE PROPERTIES COMPANY, PO BOX 33427, ST. PAUL, MN, 55133-3427, US

(21) Appl. No.: 11/295,859

(22) Filed: Dec. 7, 2005

(51) Int. Cl. C11D 7/32

(52) U.S. Cl. 510/175

(57) ABSTRACT

Compositions consisting essentially of the reaction product (including unreacted components) obtained by mixing (a) one or more selected fluorinated compounds and (b) one or more selected organic agents and providing in-situ generation of fluoride ions. Also, kits for forming such compositions and methods for using such compositions.

### FIELD OF INVENTION

This invention relates to compositions for in situ generation of fluoride ion, kits for preparing such compositions, and methods utilizing such compositions, e.g., in cleaning and processing semiconductors and integrated circuits including silicon and GaAs substrates.

### BACKGROUND

The use of microelectronic devices, such as integrated circuits, flat panel displays and microelectromechanical systems, has burgeoned in new business and consumer electronic equipment, such as personal computers, cellular phones, electronic calendars, personal digital assistants, and medical electronics. Such devices have also become an integral part of more established consumer products such as televisions, stereo components and automobiles.

These devices in turn contain one or more very high quality semiconductor chips made from silicon wafers containing many layers of circuit patterns. Typically nearly 350 processing steps are required to convert a bare silicon wafer surface to a semiconductor chip of sufficient complexity and quality to be used, for example, in high performance logic devices found in today's personal computers. The most common processing steps of semiconductor chip manufacture are wafer-cleaning steps, accounting for over 10% of the total processing steps. These cleaning steps are normally one of two types: oxidative and etch. During oxidative cleaning steps, oxidative compositions are used to oxidize the silicon or polysilicon surface, typically by contacting the wafer with aqueous peroxide or ozone solution. During etch cleaning steps, etching compositions are used to remove native and deposited silicon oxide films and organic contaminants from the silicon or polysilicon surface before gate oxidation or epitaxial deposition, typically by contacting the wafer with aqueous acid. See, for example, L. A. Zazzera and J. F. Moulder, J. Electrochem. Soc., 136, No. 2, 484 (1989). The ultimate performance of the resulting semiconductor chip will depend greatly on how well each cleaning step has been conducted.

Microelectromechanical systems (MEMS) (also called micromachines or micromechanical devices) are small mechanical devices that can be made using traditional integrated circuit manufacturing techniques. Typical devices include motors, gears, accelerometers, pressure sensors, actuators, mirrors, personal information carriers, biochips, micropumps and valves, flow sensor and implantable medical devices and systems. The manufacture of MEMS results in a chip, or die, which contains the moving pieces of the device made from silicon or polycrystalline silicon (polysilicon) encased in silicon oxide. The die can also contain the circuitry necessary to run the device. One of the final steps in the manufacture of MEMS is commonly referred to as release-etch and typically consists of an aqueous etch utilizing ion-containing compositions, e.g., hydrofluoric acid (HF), to remove the silicon oxide to free, or release, the silicon or polysilicon pieces and allow them to move.

For etch cleaning steps, the composition of choice has been dilute aqueous hydrofluoric acid (HF) and, to a lesser extent, hydrochloric acid (HCl). Currently, many semiconductor fabricators employ an “HF-last” etch cleaning process consisting of an etching step using dilute aqueous hydrofluoric acid to etch oxides.

Another important cleaning process in semiconductor chip manufacture is the removal of residues left behind from plasma ashing or etching of dielectric, photoresist or metals. The removal of these “post-etch residues” is challenging because of their multicomponent nature (i.e., the residues are typically comprised of both organic and inorganic compounds) and because the residues are adjacent to sensitive device features that must not be damaged during residue removal. Etch cleaning processes directed at removing “post-etch residues” will often utilize an aqueous HF composition in a first step, followed by a multi-step process to remove inorganic components of the residue. For instance, ethylene glycol-HF—NH₄F aqueous solutions are widely used for the removal of “post-etch residues” from metal lines, and dilute aqueous HF is often used to remove cap and side wall veil residues after shallow trench isolation etching. See, for example, S. Y. M. Chooi et al., Electrochem. Soc., Proceedings, “Sixth International Symposium on Cleaning Technology in Semiconductor Device Manufacturing,” 99-35 (1999).

However, etch cleaning of silicon surfaces with aqueous HF compositions has presented many problems to the semiconductor chip manufacturer. For example, contact with aqueous HF compositions renders the silicon surface hydrophobic and thus very susceptible to contamination by particles such as silicon oxides and other inorganic and organic materials. To remove these particles, the etched wafer is typically rinsed with deionized water, ethyl alcohol or isopropyl alcohol and is dried prior to subsequent processing. Unfortunately, the rinse does not always effectively remove these residual particles from the wafer, as the low energy silicon wafer surface is not easily wet by rinsing compositions which inherently have high surface tensions. In addition, rinsing with deionized water gives rise to slow drying time, while rinsing with alcohol introduces a potential fire hazard.

Another problem with employing aqueous HF compositions for etch cleaning is the slow rate of etching realized, possibly caused by deactivation of HF by water. To overcome this slow etch rate, most aqueous HF etching compositions need to incorporate at least 0.5% HF by weight. The slow etch rate of aqueous HF solutions can be of particular importance for MEMS devices. Silicon oxide dimensions in MEMS vary but are typically on the order of 1 μm thick with lateral dimensions of 10 to 500 μm. Slower etch rates lead to longer processing times. Etch assist holes are often added to polysilicon structures for which large, narrow regions of silicon oxide must be removed, such as for the release of micro-mirrors, in order to accommodate the slow etch rate of aqueous HF solutions and reduce etch times. The etch assist holes may adversely affect the ultimate device performance.

U.S. Pat. No. 6,492,309 (Behr et al.) discloses solvent compositions comprising anhydrous hydrogen fluoride or onium complexes thereof in fluorinated solvents and certain co-solvents and their use for etching, e.g., of microelectromechanical devices. The compositions disclosed therein are made by mixing anhydrous hydrogen fluoride or an onium complex thereof with the specified solvents and co-solvent. This entails handling of anhydrous hydrogen fluoride or onium complexes thereof which presents certain safety challenges and difficulty.

A need exists for fluoride ion-containing surface treatment compositions that are convenient to prepare and use, e.g., for etching and cleaning operations.

### SUMMARY OF INVENTION

The present invention provides compositions for in situ generation of fluoride ion, kits for preparing such compositions, and methods utilizing such compositions. Compositions of the invention are typically non-aqueous, making them well suited for a number of known applications of fluoride-containing compositions. As a result of the invention, one can obtain and utilize fluoride ion-containing compositions without directly handling the difficult-to-handle hydrogen fluoride.

In one aspect, this invention relates to compositions that provide in situ generation of fluoride ions, thus providing a treating composition useful for cleaning and etching applications, e.g., in semiconductor and integrated circuit manufacture. In brief summary, compositions of the invention are non-aqueous compositions consisting essentially of the reaction product (including unreacted fluorinated compound(s) and organic agent(s) obtained by mixing (a) one or more fluorinated compounds, e.g., selected from the group consisting of segregated hydrofluoroethers, for example, methoxynonafluorobutane and ethoxynonafluorobutane, and (b) one or more organic agents, e.g., selected from the group consisting of amides and lactams, e.g., N,N-dimethyl formamide and N-methyl-2-pyrrolidone. When such components are combined, it has been discovered, in situ formation of fluoride ions occurs, yielding compositions containing relatively low concentration of fluoride ions but which are useful for etching, removal of residues, rinsing and drying. Compositions of the invention may be rendered non-flammable by appropriate selection of the fluorinated compound. Advantageously, compositions of the invention are substantially non-aqueous and may be used with a variety of substrates including, for example, silicon, germanium, GaAs, InP and other Group III-V and II-VII compound semiconductors. It will be understood, due to the large number of processing steps involved in integrated circuit manufacture, that the substrate may include layers of silicon, polysilicon, metals and oxides thereof, resists, masks and dielectrics.

In another aspect, the present invention provides kits for forming compositions as described herein. In brief summary, kits of the invention comprise (a) one or more fluorinated compounds, e.g., selected from the group consisting of segregated hydrofluoroethers, for example, methoxynonafluorobutane and ethoxynonafluorobutane and (b) one or more organic agents, e.g., selected from the group consisting of amides and lactams, e.g., N,N-dimethyl formamide and N-methyl-2-pyrrolidone.

In another aspect, the present invention provides methods for treating, e.g., etching and/or cleaning substrates. The method comprises contacting a substrate with a treating composition as described herein and utilizing the in situ generated fluoride ion content for desired surface treatment; then separating the cleaning composition from the processed substrate. The cleaning process makes efficient use of the available fluoride ion content and achieves an etch cleaning rate comparable to that of conventional aqueous hydrogen fluoride compositions albeit with a relatively low hydrogen fluoride concentration and without the well-known difficulties of working with anhydrous hydrogen fluoride and well-known problems and detriments of working with aqueous-based compositions.

### DETAILED DESCRIPTION OF ILLUSTRATIVE EMBODIMENTS

Illustrative Utility

Compositions of the invention are useful in the various cleaning operations performed on substrates such as those that may be required for subsequent operations in the manufacture of semiconductors. As used herein “cleaning” of substrates will refer to any of etching, removal of residues and/or particulates, passivating a substrate (e.g., hydrogen-terminating silicon to inhibit oxidation upon exposure to ambient conditions), rinsing and drying. As used herein “substrate” will refer to wafers and chips used in semiconductor manufacture, including silicon, polysilicon, germanium, GaAs, InP, and other Group III-V and II-VII compound semiconductors. The compositions can effectively remove both inorganic particles, such as silicon oxides and other inorganic oxides, and organic residues, such as oils and greases, from the silicon wafer surface to expose a hydrophobic silicon surface and additionally convert hydrophilic silicon oxides to hydrophobic silicon hydrides. As a result, many of these cleaning steps (e.g., etching, rinsing and drying) can be combined into a single step. Additionally the present composition is useful in the removal of “post-etch residues” left behind from plasma ashing or etching of dielectric, photoresist or metals.

The cleaning composition and method of this invention can improve manufacturing efficiency by lowering defects to increase wafer yield, or by decreasing cleaning times to increase wafer production. Further advantages of this invention include: (1) reduced processing time due to fewer chemical processing steps required; (2) reduced flammability of the cleaning compositions (e.g., as compared to compositions containing high levels of isopropyl alcohol); (3) elimination of aqueous hydrogen fluoride rinsing steps that can leave particles on the wafer surface; (4) less particles remaining on “hydrogen fluoride last” treated substrates, possibly due to improved wetting of the substrate; (5) better removal of residues having both inorganic and organic components; and (6) faster etching rates than realized with conventional etch cleaning processes employing aqueous hydrogen fluoride etching compositions and (7) less corrosive relative to prior art aqueous systems.

The improved performance is due in part to the low surface tension and low viscosity of the fluorinated compounds used, and hence of the resultant compositions. The low surface tension of the composition contributes to the improved wetting of the surfaces, and the low viscosity contributes to improved separation of the processed substrate from the cleaning composition, better draining of the composition from the surface, and more efficient evaporation of the residue from the surface. The surface tensions of compositions of the invention are generally less than 20 dynes/cm and preferably between 10 and 20 dynes/cm when measured at 25° C. The viscosity values are generally less than 5, and preferably less than 1 centistokes at 25° C.

Compositions of this invention are preferably non-flammable, which is defined herein as having a flash point of greater than about 140° F. (about 60° C.) when tested according to ASTM D3278-89. Because the compositions may be used in the cleaning and processing of electronic devices, it is preferred that all components of the composition be highly pure and have low concentrations of particulates, metals and non-volatile residues. In particular, cleaning compositions of the invention e.g., those used in the process of the invention, should have less than 3 particles (of greater than 5.0 micron diameter) per ml, less that 5000 parts per trillion of metals, and less than 250 parts per trillion of non-volatile residues.

Fluorinated Compounds

Compositions of the invention contain at least one fluorinated compound that, among other purposes and functions, is the source of the in situ-formed fluoride ions.

For rapid evaporation during the drying step, the fluorinated compound should preferably have a boiling point of less than about 120° C. at atmospheric pressure. It is believed that the very low surface energy of the fluorinated compound renders the resultant composition much more effective as a cleaning composition: the low surface tension of fluorinated compounds effectively wet the substrates much more readily than the conventional aqueous and alcoholic compositions of the prior art.

Useful fluorinated solvents meeting these criteria include hydrofluoroethers (“HFEs”), hydrofluorocarbons (“HFCs”), hydrohalofluoroethers (“HHFEs”) and hydrochlorofluorocarbons (“HCFCs”).

Fluorinated compounds useful in the present invention include nonionic, partially fluorinated hydrocarbons that may be linear, branched, or cyclic, and optionally may contain one or more additional catenary heteroatoms, such as nitrogen or oxygen. The fluorinated compound may be selected from the group consisting of partially-fluorinated alkanes, amines, ethers, and aromatic compounds. The fluorinated compound is non-functional, i.e., lacking functional groups that are polymerizable, reactive toward acids, bases, oxidizing agents, reducing agents or nucleophiles. Preferably, the number of fluorine atoms exceeds the number of hydrogen atoms in the fluorinated compound. To be non-flammable, the relationship between the number of fluorine, hydrogen, and carbon atoms can preferably be related in that the number of fluorine atoms is equal to or exceeds the sum of the number of hydrogen atoms and number of carbon-carbon bonds: # F atoms is greater than or equal to (# H atoms+# C—C bonds). Although typically not preferred due to environmental concerns, the partially fluorinated compounds may optionally contain one or more chlorine atoms provided that where such chlorine atoms are present there are at least two hydrogen atoms on the geminal or adjacent carbon atom(s).

The fluorinated compounds are partially or incompletely fluorinated, i.e., contain at least one aliphatic hydrogen atom. Perfluorinated compounds, since they lack chlorine atoms, are not ozone-depleting agents, but these compounds may exhibit a global warming potential (GWP) due to their long atmospheric lifetimes, and are generally not good solvents for hydrogen fluoride. It is preferred that the fluorinated compound contains at least one aliphatic or aromatic hydrogen atom in the molecule. These compounds generally are thermally and chemically stable, yet are much more environmentally acceptable in that they degrade in the atmosphere and thus have a low global warming potential, in addition to a zero ozone depletion potential, and better solvency properties.

Partially fluorinated liquids, containing one or more aliphatic or aromatic hydrogen atoms, may be employed as the fluorinated compounds of the invention. Such liquids typically contain from 3 to 20 carbon atoms and may optionally contain one or more catenary heteroatoms, such as divalent oxygen or trivalent nitrogen atoms. Useful partially fluorinated solvents include cyclic and non-cyclic fluorinated alkanes, amines, ethers, and any mixture or mixtures thereof.

One class of partially fluorinated liquids useful as fluorinated compounds in the invention are hydrofluorocarbons; i.e. compounds having only carbon, hydrogen and fluorine, and optionally catenary divalent oxygen and/or trivalent nitrogen. Such compounds are nonionic, may be linear or branched, cyclic or acyclic. Such compounds are of the formula CₙHₘF₂ₙ₊₂₋ₘ, where n is from about 3 to 20 inclusive, m is at least one, and where one or more non-adjacent —CF₂— groups may be replaced with catenary oxygen or trivalent nitrogen atoms. Preferably, the number of fluorine atoms is equal to or greater than the number of hydrogen atoms, and more preferably the number of fluorine atoms is equal to or exceeds the sum of the combined number of hydrogen atoms and carbon-carbon bonds of fluorine atoms.

A preferred class of hydrofluorocarbon liquids particularly useful in the present invention comprises hydrofluoroethers of the general formula:
(R₁—O)ₓ-R₂ (I)
where, in reference to Formula I, x is a number from 1 to 3 inclusive and R₁ and R₂ are the same or are different from one another and are selected from the group consisting of alkyl, aryl, and alkylaryl groups and their derivatives. At least one of R₁ and R₂ contains at least one fluorine atom, and at least one of R₁ and R₂ contains at least one hydrogen atom. R₁ and R₂ may also be linear, branched, cyclic or acyclic and, optionally, one or both of R₁ and R₂ may contain one or more catenary heteroatoms, such as trivalent nitrogen or divalent oxygen. Preferably the number of fluorine atoms is equal to or greater than the number of hydrogen atoms, and more preferably the number of fluorine atoms is equal to or exceeds the sum of the combined number of hydrogen atoms and carbon-carbon bonds. Although not preferred, due to environmental concerns, R₁ or R₂ or both of them optionally may contain one or more chlorine atoms provided that where such chlorine atoms are present there are at least two hydrogen atoms on the R₁ or R₂ group on which they are present.

Preferably, the fluorinated compounds used in the present invention hydrofluoroethers of the formula:
R_{f}-O—R (II)
where, in reference to Formula II above, R_{f} and R are as defined for R₁ and R₂ of Formula I, except that R_{f} contains at least one fluorine atom, and R contains no fluorine atoms. Such ethers may be described as segregated ethers in that the fluorinated carbons are segregated from the non-fluorinated carbons by the ether oxygen atom. More preferably, R is an acyclic branched or straight chain alkyl group, such as methyl, ethyl, n-propyl, iso-propyl, n-butyl, i-butyl, or t-butyl, and R_{f} is preferably a fluorinated derivative of a cyclic or acyclic, branched or straight chain alkyl group having from 3 to about 14 carbon atoms, such as n-C₄F₉—, i-C₄F₉—, i-C₃F₇, (n-C₃F₇)CF— or cyclo-C₆F₁₁—. R_{f} may optionally contain one or more catenary heteroatoms, such as trivalent nitrogen or divalent oxygen atoms.

In a preferred embodiment, R₁ and R₂, or R_{f} and R, are chosen so that the compound has at least three carbon atoms, and the total number of hydrogen atoms in the compound is at most equal to the number of fluorine atoms. In the most preferred embodiment, R₁ and R₂ or R_{f} and R are chosen so that the compound has at least three carbon atoms, and more preferably number of fluorine atoms is equal to or exceeds the sum of the number of combined hydrogen atoms and carbon-carbon bonds.

Representative compounds described by Formula II useful in the present invention include, but are not limited to, the following compounds:

| | | |
|---|---|---|
| (C₂F₅)₂NCF₂CF₂OCH₃ | C₂F₅CF(OCH₃)CF(CF₃)₂ | (CF₃)₂N(CF₂)₃OCH₃ |
| | | (CF₃)₂N(CF₂)₂OC₂H₅ |
| | | (C₂F₅)₂NCF₂CF₂OCH₃ |
| (CF₃)₂CFOCH₃ | (CF₃)₃C—OCH₃ | (CF₃)₂C—OC₂H₅ |
| C₅F₁₁OC₂H₅ | CF₃OC₂F₄OC₂H₅ | 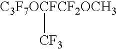 |
| 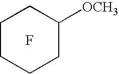 | n-C₄H₉OC₂H₅ | n-C₃F₇OCH₃ |
| n-C₄F₉OCH₃ | 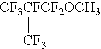 | 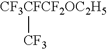 |
| C₃F₇CF(OCH₃)CF(CF₃)₂ | C₂F₅CF(OC₂H₅)CF(CF₃)₂ | CF₃CF(OC₂H₅)CF(CF₃)₂ |
| 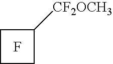 | CF₃CF(OCH₃)CF(CF₃)₂ | nC₃F₇OC₂H₅ |
| 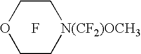 | 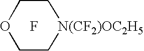 | 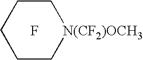 |
| 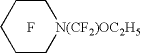 | 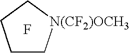 | 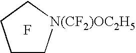 |

wherein cyclic structures designated with an interior “F” are perfluorinated.

Particularly preferred segregated hydrofluoroethers of Formula II include those wherein R_{f} is perfluorinated, for example: n-C₃F₇OCH₃, (CF₃)₂CFOCH₃, n-C₄F₉OCH₃, (CF₃)₂CFCF₂OCH₃, n-C₃F₇OC₂H₅, n-C₄F₉OC₂H₅, (CF₃)₂CFCF₂OC₂H₅, (CF₃)₃COCH₃, (CF₃)₃COC₂H₅, and mixtures thereof. Segregated hydrofluoroethers are available as 3M™ NOVEC™ HFE-7100 and HFE-7200 Engineered Fluids from 3M Company, St. Paul, Minn.

Useful non-segregated hydrofluoroethers include alpha-, beta- and omega-substituted hydrofluoroalkyl ethers such as those described in U.S. Pat. No. 5,658,962 (Moore et al.), which can be described by the general structure shown in Formula III:
X—[R_{f}′—O]_{y}R″H (III)
wherein:

X is either F, H, or a perfluoroalkyl group containing from 1 to 3 carbon atoms;

each R_{f}′ is independently selected from the group consisting of —CF₂—, —C₂F₄—, and —C₃F₆—;

R″ is a divalent organic radical having from 1 to about 3 carbon atoms, and is preferably perfluorinated; and

y is an integer from 1 to 7, preferably from 1 to 3;

wherein when X is F, R″ contains at least one F atom, and wherein the sum of the number of carbon atoms in the R_{f}′ group(s) and the number of carbon atoms in the R″ group is between 4 and about 8.

Representative compounds described by Formula III useful in the present invention include, but are not limited to, the following compounds: HCF₂OCF₂OCF₂H, HCF₂OCF₂OC₂F₄OCF₂H, C₃F₇OCH₂F, HCF₂OC₂F₄OCF₂H, HCF₂OCF₂OCR₂OCF₂H, HCF₂OC₂F₄OC₂F₄OCF₂H, HC₃F₆OCH₃, HC₃F₆OC₃F₆H, HC₃F₆OC₃F₆H, C₄F₉OC₂F₄H, C₅F₁₁OC₂F₄H, C₆F₁₃OCF₂H, and C₃F₇O[CF(CF₃)CF₂O]ₚCF(CF₃)H, wherein p=0 to 1

Useful non-flammable, non-segregated hydrofluoroethers include C₄F₉OC₂F₄H, C₆F₁₃OCF₂H, HC₃F₆OC₃F₆H, C₃F₇OCH₂F, HCF₂OCF₂OCF₂H, HCF₂OCF₂CF₂OCF₂H, HC₃F₆OCH₃, HCF₂OCF₂OC₂F₄OCF₂H, and mixtures thereof. Non-segregated hydrofluoroethers specialty liquids are available from Ausimont Corp., Milano, Italy, under the GALDEN H™.

Useful fluorinated solvents also include hydrofluorocarbons (HFCs) having a 3- to 8-carbon backbone. The carbon backbone can be straight, branched, cyclic, or mixtures of these. Useful HFCs include compounds having more than approximately 5 molar percent fluorine substitution, or less than about 95 molar percent fluorine substitution, based on the total number of hydrogen and fluorine atoms bonded to carbon, but having essentially no substitution with other atoms (e.g., chlorine). Useful HFCs can be selected from compounds of Formula IV:
CₙHₘF₂ₙ₊₂₋ₘ (IV)
wherein n is at least 3, and m is at least one.

Representative compounds of Formula IV include CF₃CH₂CF₂H, CF₂HCF₂CH₂F, CH₂FCF₂CFH₂, CF₂HCH₂CF₂H, CF₂HCFHCF₂H, CF₃CFHCF₃, and CF₃CH₂CF₃; CHF₂(CF₂)₂CF₂H, CF₃CF₂CH₂CH₂F, CF₃CH₂CF₂CH₂F, CH₃CHFCF₂CF₃, CF₃CH₂CH₂CF₃, CH₂FCF₂CF₂CH₂F, CF₃CH₂CF₂CH₃, CHF₂CH(CF₃)CF₃, and CHF(CF₃)CF₂CF₃; CF₃CH₂CHFCF₂CF₃, CF₃CHFCH₂CF₂CF₃, CF₃CH₂CF₂CH₂CF₃, CF₃CHFCHFCF₂CF₃, CF₃ CH₂CH₂CF₂CF₃, CH₃CHFCF₂CF₂CF₃, CF₃CF₂CF₂CH₂CH₃, CH₃CF₂CF₂CF₂CF₃, CF₃CH₂CHFCH₂CF₃, CH₂FCF₂CF₂CF₂CF₃, CHF₂CF₂CF₂CF₂CF₃, CH₃CF(CHFCHF₂)CF₃, CH₃CH(CF₂CF₃)CF₃, CHF₂CH(CHF₂)CF₂CF₃, CHF₂CF(CHF₂)CF₂CF₃, and CHF₂CF₂CF(CF₃)₂; CHF₂(CF₂)₄CF₂H, (CF₃CH₂)₂CHCF₃, CH₃CHFCF₂CHFCHFCF₃, HCF₂CHFCF₂CF₂CHFCF₂H, H₂CFCF₂CF₂CF₂CF₂CF₂H, CHF₂CF₂CF₂CF₂CF₂CHF₂, CH₃CF(CF₂H)CHFCHFCF₃, CH₃CF(CF₃)CHFCHFCF₃, CH₃CF(CF₃)CF₂CF₂CF₃, CHF₂CF₂CH(CF₃)CF₂CF₃, and CHF₂CF₂CF(CF₃)CF₂CF₃; CH₃CHFCH₂CF₂CHFCF₂CF₃, CH₃(CF₂)₅CH₃, CH₃CH₂(CF₂)₄CF₃, CF₃CH₂CH₂(CF₂)₃CF₃, CH₂FCF₂CHF(CF₂)₃CF₃, CF₃CF₂CF₂CHFCHFCF₂CF₃, CF₃CF₂CF₂CHFCF₂CF₂CF₃, CH₃CH(CF₃)CF₂CF₂CF₂CH₃, CH₃CF(CF₃)CH₂CFHCF₂CF₃, CH₃CF(CF₂CF₃)CHFCF₂CF₃, CH₃CH₂CH(CF₃)CF₂CF₂CF₃, CHF₂CF(CF₃)(CF₂)₃CH₂F, CH₃CF₂C(CF₃)₂CF₂CH₃, CHF₂CF(CF₃)(CF₂)₃CF₃; CH₃CH₂CH₂CH₂CF₂CF₂CF₂CF₃, CH₃(CF₂)₆CH₃, CHF₂CF(CF₃)(CF₂)₄CHF₂, CHF₂CF(CF₃)(CF₂)₄CHF₂, CH₃CH₂CH(CF₃)CF₂CF₂CF₂CF₃, CH₃CF(CF₂CF₃)CHFCF₂CF₂CF₃, CH₃CH₂CH₂CHFC(CF₃)₂CF₃, CH₃C(CF₃)₂CF₂CF₂CF₂CH₃, CH₃CH₂CH₂CF(CF₃)CF(CF₃)₂ and CH₂FCF₂CF₂CHF(CF₂)₃CF₃.

Representative HFCs include CF₃CFHCFHCF₂CF₃, C₅F₁₁H, C₆F₁₃H, CF₃CH₂CF₂H, CF₃CF₂CH₂CH₂F, CHF₂CF₂CF₂CHF₂, 1,2-dihydroperfluorocyclopentane and 1,1,2-trihydroperfluorocyclopentane. Useful HFCs include HFCs available under the VERTREL™, available from E. I. duPont de Nemours & Co. (e.g., CF₃CHFCHFCF₂CF₃); under the ZEORORA-H™, available from Nippon Zeon Co. Ltd., Tokyo, Japan; and under the HFC designation from AlliedSignal Chemicals, Buffalo, N.Y.

Useful fluorinated solvents also include hydrohalofluoro ethers (HHFEs). For the present invention, HHFEs are defined as ether compounds containing fluorine, non-fluorine halogen (i.e., chlorine, bromine, and/or iodine) and hydrogen atoms. An important subclass of HHFEs is perfluoroalkylhaloethers (PFAHEs). PFAHEs are defined as segregated ether compounds having a perfluoroalkyl group and a haloalkyl group having carbon-bonded hydrogen atoms and halogen atoms, wherein at least one of the halogen atoms is chlorine, bromine, or iodine. Useful PFAHEs include those described by the general structure shown in Formula V:
R_{f}-O—CₐH_{b}F_{c}X_{d} (V)
wherein R_{f} is a perfluoroalkyl group preferably having at least about 3 carbon atoms, most preferably from 3 to 6 carbon atoms, and optionally containing a catenary heteroatom such as nitrogen or oxygen; X is a halogen atom selected from the group consisting of bromine, iodine, and chlorine; “a” preferably is from about 1 to 6; “b” is at least 1; “c” can range from 0 to about 2; “d” is at least 1; and b+c+d is equal to 2a+1. Such PFAHEs are described in PCT Publication No. WO 99/14175. Useful PFAHEs include c-C₆F₁₁—OCH₂Cl, (CF₃)₂CFOCHCl₂, (CF₃)₂CFOCH₂Cl, CF₃CF₂CF₂OCH₂Cl, CF₃CF₂CF₂OCHCl₂, (CF₃)₂CFCF₂OCHCl₂, (CF₃)₂CFCF₂OCH₂Cl, CF₃CF₂CF₂CF₂OCHCl₂, CF₃CF₂CF₂CF₂OCH₂Cl, (CF₃)₂CFCF₂OCHClCH₃, CF₃CF₂CF₂CF₂OCHClCH₃, (CF₃)₂CFCF(C₂F₅)OCH₂Cl, (CF₃)₂CFCF₂OCH₂Br, and CF₃CF₂CF₂OCH₂I.

Useful fluorinated compounds also include HCFCs. For the present invention, HCFCs are defined as compounds containing a carbon backbone substituted with carbon-bound fluorine, chlorine, and hydrogen atoms, e.g., CF₃CHCl₂, CH₃CCl₂F, CF₃CF₂CHCl₂, and CClF₂CF₂CHClF. However, in the long term, HCFCs may also be legislated out of production due to ozone layer degradation, albeit slower than the CFCs.

Organic Agent

Compositions of the invention comprise organic agents, e.g., selected from the group of amides and lactams, which, when mixed with the selected fluorinated compound(s), lead to formation of fluoride ions. In addition, organic agents may be selected to augment or adjust the solvating power and drying characteristics of the fluorinated compound such that the resultant composition exhibits desired performance.

Illustrative examples of organic agents that may be used in the invention include the following: alcohols (e.g., methanol, ethanol, 1-propanol, isopropanol, 2-butanol, i-butanol, and t-Butanol), amides (e.g., N,N-dimethylformamide, N-methylformamide, N,N-dimethyl acetamide, and N,N-diethyl acetamide), lactams (e.g., N-methyl-2-pyrrolidone and imidazolidinoe), amines (e.g., monoethanolamine), and sulfoxides (e.g., dimethylsulfoxide).

The organic agent must be miscible in the fluorinated compound (and vice versa) and when mixed with the fluorinated compound must cause the fluorinated compound to decompose to form fluoride ions, e.g., F⁻ and HF₂⁻.

The organic agent should be relatively volatile to facilitate evaporation from a silicon surface, with those having a boiling point of about 120° C. or less being preferred, and is preferably substantially free of other contaminants such as metals, particulates and non-volatile residues in order to effectively clean the silicon surface at the maximum rate during the manufacturing process.

Compositions of the invention will typically be made by combining the fluorinated compound and organic agent in weight ratios ranging from about 19:1 to about 1:1. Selection of the preferred ratio of components for a specific application will be dependent in part upon desired parameters of cost, toxicity, flammability, residue solvating power, and miscibility of the fluorinated compound and organic agent.

Method

In the method of the invention, a substrate, e.g., a silicon substrate, is contacted with a treating composition the product of combining a fluorinated compound and organic agent as described above, at a temperature and for a time sufficient to clean the surface of the substrate. The method may be carried out at any desired temperature and pressure at which the treating composition is in liquid form and undergoing in situ generation of fluoride ion. The speed of HF generation, and hence, etch rate, may be readily affected as desired by controlling the temperature of the cleaning composition and substrate. Typically, at one atmosphere, this will be temperatures in the range of about 18° C. to about 80° C., with temperatures in the range of about 20° C. to about 70° C. typically being preferred. In addition, the rate of solubility of residues can be readily controlled by selection of components and their proportions. The cleaning method may be used to etch the surface to remove hydrophilic silanol and siloxy groups, remove particulates or residues, rinse and dry the surface or a combination of these. The method preferably comprises the additional step of separating the cleaned substrate from the treating composition, e.g., removing it from a bath and rinsing with a suitable rinse agent.

The cleaning composition is used in the liquid state and any of the known techniques for “contacting” a substrate can be utilized. For example, a liquid cleaning composition can be sprayed, brushed or poured onto the substrate, or the substrate can be immersed in a liquid composition. Elevated temperatures, ultrasonic energy, and/or agitation can be used to facilitate the cleaning and etching. Various different solvent cleaning techniques are described by B. N. Ellis in Cleaning and Contamination of Electronics Components and Assemblies, Electrochemical Publications Limited, Ayr, Scotland, pages 182-94 (1986).

After contact, the substrate may be removed from the cleaning composition. Normally draining is sufficiently efficient to effect substantially complete removal of the cleaning composition from the surface of the substrate. This may be enhanced by the application of heat, agitation, air jets, or spinning the substrates (i.e., centrifugal removal processes) to effect more complete removal, as desired.

Additionally the cleaning process may further comprise a rinse step, to ensure complete removal of the fluoride ion from the substrate. The substrate may be rinsed in any solvent known to be useful in the wafer manufacturing process. Although alcohols are conventionally chosen in the art to remove water, their use represents a potential fire hazard and it is preferred to rinse in a non-flammable fluorinated solvent such as those previously described. The fluorinated solvent used in the rinse may be the same as or different from the fluorinated liquid used in the cleaning compositions, and a mixture of solvents may be used. Preferably the fluorinated liquid used in a rinse step is the same as used in the cleaning composition.

Normally, the compositions may be used for an extended period before replacement, renewal or purification is required. Such techniques including filtration to remove particulates, extraction to remove soluble residues or salts, distillation and decantation to recover the fluorinated solvent may be used. It will be noted that as a surface is cleaned, or etched in particular, the compositions begin to become contaminated. Removal of particulates and residues from the substrate leads to build up of these materials in the cleaning composition. In particular etching silicon produces both water and various silanols. As the concentration of water increases, it will eventually phase separate from the composition as a less dense, water-rich phase. This may be easily separated from the cleaning composition by techniques known in the art, such as decantation or use of a weir. The cleaning composition may then be recycled, especially the fluorinated component. It is generally not necessary or desirable to recover the organic agent and residual hydrogen fluoride from the spent cleaning compositions. It is generally more desirable to recover the fluorinated component and add new organic agent thereto.

In an illustrative embodiment, a mixture of n-methyl pyrrolidone (NMP, Alfa Aesar) could be combined with NOVEC™ HFE-7200 Cleaning Fluid (3M Company) in a commercial wet processing tool. The mixture would preferably be heated, by flowing through a heater, for example, an infrared heater, to elevate the temperature of the NMP/HFE-7200 mixture to a desired temperature from about 20° C. to 70° C. to yield a targeted fluoride ion concentration between 0 and 100,000 ppm. The fluoride ion containing NMP/HFE-7200 mixture could then be applied to a semiconductor wafer substrate to remove surface organic contamination (e.g., photoresist and/or polymer residue) with a target silicon oxide loss ranging from 0 to 5 micrometers.

The present invention is particularly useful in the etch and release of microelectromechanical devices. The etch cleaning and drying of MEMS has similar issues to those for semiconductor chip manufacture. Particulate contamination on micromachines can hinder movement of the device and ultimately affect device performance or cause failure. Care is taken to rinse the device with deionized water followed by ethyl alcohol or isopropanol but has similar problems to the IC in that the particles are not easily removed from devices due to the polysilicon surface energy and intricate designs.

In addition to the problem of particulate contamination, drying of MEMS following deionized water rinses or alcohol rinses can lead to a phenomenon known as stiction. Stiction can be described as the adhesion of two surfaces due to adhesives forces as well as frictional forces. Polysilicon devices are typically 0.2 to 4.0 μm, but can range up to hundreds of μm, with lateral dimensions anywhere from 1 to 500 μm. The high surface area of these structures along with the tight tolerances between structures makes stiction a very troublesome problem. Stiction of microdevices can occur during use of the device or as a result of capillary effects during the drying of the device following the release etch process. See, for example, R. Maboudian and R. T. Howe, J. Vac. Sci. Technol. B, 15(1), 1-20 (1997). The high surface tensions of some rinses can greatly exacerbate the capillary effects and lead to a higher incidence of microstructure stiction following the release-etch and drying steps

In yet another aspect, this invention relates to a cleaning process for silicon or polysilicon part in MEMS chip with a homogeneous cleaning composition as described herein. The present invention provides a wafer cleaning composition with low surface tension that easily penetrates the intricate microstructures and wets the surfaces on MEMS substrates. The cleaning composition is easily removed from MEMS and leaves a dry, hydrophobic surface without residual or trapped water that could be present from a high surface tension aqueous cleaning composition. In contrast to the prior art, the present invention provides a method for the etch and release of microelectromechanical devices that etches and releases MEMS with no, or fewer, etch assist holes in MEMs device. Additionally the composition etches and releases while preventing stiction between said MEMs substrates.

As used herein, “micromechanical device” refers to micrometer-sized mechanical, optomechanical, electromechanical, or optoelectromechanical device. Various technology for fabricating micromechanical devices is available using the Multi-User MEMS Processes (MUMPs) from Cronos Integrated Microsystems located at Research Triangle Park, N.C. One description of the assembly procedure is described in “MUMPs Design Handbook”, revision 5.0 (2000) available from Cronos Integrated Microsystems.

Polysilicon surface micromachining adapts planar fabrication process steps known to the integrated circuit (IC) industry to manufacture microelectromechanical or micromechanical devices. The standard building-block processes for polysilicon surface micromachining are deposition and photolithographic patterning of alternate layers of low-stress polycrystalline silicon (also referred to as polysilicon) and a sacrificial material (e.g., silicon dioxide or a silicate glass). Vias etched through the sacrificial layers at predetermined locations provide anchor points to a substrate and mechanical and electrical interconnections between the polysilicon layers. Functional elements of the device are built up layer by layer using a series of deposition and patterning process steps. After the device structure is completed, it can be released for movement by removing the sacrificial material using a selective etchant such as hydrofluoric acid (HF) which does not substantially attack the polysilicon layers.

The result is a construction system generally consisting of a first layer of polysilicon which provides electrical interconnections and/or a voltage reference plane, and additional layers of mechanical polysilicon which can be used to form functional elements ranging from simple cantilevered beams to complex electromechanical systems. The entire structure is located in-plane with the substrate. As used herein, the term “in-plane” refers to a configuration generally parallel to the surface of the substrate and the terms “out-of-plane” refer to a configuration greater than zero degrees to about ninety degrees relative to the surface of the substrate.

Typical in-plane lateral dimensions of the functional elements can range from one micrometer to several hundred micrometers, while the layer thicknesses are typically about 1 to 2 micrometers. Because the entire process is based on standard IC fabrication technology, a large number of fully assembled devices can be batch-fabricated on a silicon substrate without any need for piece-part assembly.

### EXAMPLES

The present invention will be further described with reference to the following non-limiting examples. All parts, percentages and ratios are by weight unless otherwise specified.

Materials

| Designator | Name | Availability |
|---|---|---|
| HFE 7100 | 3M NOVEC ™ Engineered | 3M Company, St Paul, MN |
| | Fluid HFE 7100 | |
| HFE 7200 | 3M NOVEC ™ Engineered | 3M Company, St Paul, MN |
| | Fluid HFE 7200 | |
| NMP | n-methyl pyrrolidone | Alfa Aesar, Ward Hill, MA |
| DMF | Dimethylformamide | Alfa Aesar, Ward Hill, MA |

Test Methods

Fluoride Ion Measurement

Fluoride ion content was measured by mixing 20 grams of test sample with 10 grams of water in a 60 milliliter NALGENE™ HDPE bottle. The bottle was sealed and shaken for 30 minutes then allowed to phase separate. The fluoride ion was extracted into the aqueous phase. The fluoride ion concentration was measured by taking a 1 milliliter sample of the aqueous phase and combining it with 1 milliliter of TISAB II solution (Thermo Electron Corporation, Waltham, Mass.). The aqueous fluoride/TISAB II solution potential was measured with an ion probe (Model Orion 720A Advanced Ion Selective Meter, Thermo Electron Corporation). This measurement was converted to a fluoride ion concentration using a linear model generated from the least squares fit of three standard measurements at 1 ppm, 10 ppm and 100 ppm.

### Examples 1-5

### Fluoride Ion Generation

Mixtures of organic agent and hydrofluoroether (HFE) were made by combining the agent and HFE in a 500 milliliter NALGENE HDPE bottle, sealing the bottle and aging the mixtures at ambient temperature (about 25° C.) for various time periods. The generation of fluoride ions, in parts per million (ppm), was measured as described above. The results are shown in Table 1

TABLE 1

| | | Fluoride Ion Concentration (ppm) | | | |
|---|---|---|---|---|---|
| | | Aged 3 | Aged | | Aged 14 |
| Example | Mixture (w/w) | hours | 3 days | Aged 7 days | days |
| 1 | NMP/HFE | 0.05 | 0.67 | 1.87 | 4.15 |
| | 7100 (5/95) | | | | |
| 2 | NMP/HFE | 15.69 | 49.96 | 91.14 | 148.88 |
| | 7100 (20/80) | | | | |
| 3 | NMP/HFE | 0.69 | 4.82 | 8.61 | 13.66 |
| | 7200 (20/80) | | | | |
| 4 | DMF/HFE | 1.52 | 22.28 | 56.06 | 115.71 |
| | 7100 (20/80) | | | | |
| 5 | DMF/HFE | 0.31 | 1.53 | 3.46 | 6.68 |
| | 7200 (20/80) | | | | |

### Example 6

### Silicon Oxide Etch

A silicon oxide film deposited on a silicon substrate was measured with a film thickness monitor (Model NanoSpec® 6100UV Tabletop Film Analysis System, Nanometrics Incorporated, Milpitas, Calif.). The silicon oxide film and substrate were then placed into a 100 milliliter polypropylene beaker containing a mixture of NMP/HFE 7100 (20/80, w/w) that had been aged for 6 weeks at ambient temperature (about 25° C.). The fluoride ion concentration of this mixture was measured as described above. A sufficient volume of the mixture was used to cover the silicon oxide film. After 30 minutes at ambient temperature (about 25° C.), the silicon oxide thickness was measured again. Qualitative surface hydrophobicity was determined by examining the morphology of water droplets placed on the post-processed wafer substrate. The substrate surface prior to treatment was determined to be hydrophobic. The results are shown in Table 2 below.

TABLE 2

| | | Fluoride | | | | |
|---|---|---|---|---|---|---|
| | | Ion | Initial | Final | Thickness | |
| | | Conc. | Thickness | Thickness | Change | Surface |
| Example | Mixture | (ppm) | (angstroms) | (angstroms) | (angstroms) | Hydrophobicity |
| 6 | NMP/HFE | 298.81 | 1011.7 | 1002.6 | −9.1 | Hydrophilic |
| | 7100 (20/80) | | | | | |

### Example 7

### Fluoride Ion Generation at Elevated Temperature

The effect of temperature on the generation of fluoride ion was determined by preparing a mixture of NMP/HFE 7100 (25/75 w/w) as described above and then aging it at 100° C. for 3 days. The fluoride ion concentration was measured as described above and found to be 31,000 ppm.

Various modifications and alterations of this invention will become apparent to those skilled in the art without departing from the scope and spirit of this invention.

What is claimed is:

1. A non-aqueous composition consisting essentially of the reaction product obtained by mixing (a) one or more fluorinated compounds selected from the group consisting of segregated hydrofluoroethers and (b) one or more organic agents selected from the group consisting of lactams and amides.

2. The composition of claim 1 wherein the weight ratio of said one or more fluorinated compounds to said one or more organic agents is from about 19:1 to about 1:1.

3. The composition of claim 1 wherein said fluorinated compounds are selected from the group consisting of methoxynonafluorobutane, ethoxynonafluorobutane, and combinations thereof.

4. The composition of claim 1 wherein said organic agents are selected from the group consisting of N,N-dimethylformamide, N-methyl-2-pyrrolidone, and combinations thereof.

5. The composition of claim 1 having less than 3 particles (of greater than 5.0 micron diameter) per milliliter, less that 5000 parts per trillion of metals, and less than 250 parts per trillion of non-volatile residues.

6. The composition of claim 1 wherein substantially all of the fluoride ion present therein is resultant from the interaction of said fluorinated compounds with said organic agents.

7. A kit comprising (a) one or more fluorinated compounds selected from the group consisting of segregated hydrofluoroethers and (b) one or more organic agents selected from the group consisting of lactams and amides.

8. The kit of claim 7 wherein the weight ratio of said one or more fluorinated compounds to said one or more organic agents is from about 19:1 to about 1:1.

9. The kit of claim 7 wherein said fluorinated compounds are selected from the group consisting of methoxynonafluorobutane, ethoxynonafluorobutane, and combinations thereof.

10. The kit of claim 7 wherein said organic agents are selected from the group consisting of N,N-dimethylformamide, N-methyl-2-pyrrolidone, and combinations thereof.

11. A method of treating a substrate comprising contacting said substrate with a non-aqueous treating composition consisting essentially of the reaction product obtained by mixing (a) one or more fluorinated compounds and (b) one or more organic agents.

12. The method of claim 11 wherein said one or more fluorinated compounds are one or more fluorinated compounds selected from the group consisting of methoxy nonafluorobutone and ethoxy nonafluorobutone.

13. The method of claim 11 wherein the number of fluorine atoms of said fluorinated compound is equal to or greater than the number of hydrogen atoms.

14. The method of claim 11 wherein said fluorinated compounds are selected from the group consisting of hydrofluoroethers of the general formula:
(R₁—O)ₓ-R₂
wherein x is a number from 1 to 3 inclusive, R₁ and R₂ are the same or are different from one another and are selected from the group consisting of substituted and unsubstituted alkyl, aryl, and alkylaryl groups, wherein at least one of R₁ and R₂ contains at least one fluorine atom, and at least one of R₁ and R₂ contains at least one hydrogen atom.

15. The method of claim 14 wherein said fluorinated compounds are selected from the group consisting of hydrofluoroethers of the general formula:
R_{f}-O—R
where R_{f} and R are selected from the group consisting of substituted and unsubstituted alkyl, aryl, and alkylaryl groups, and wherein R_{f} contains at least one fluorine atom, and R contains no fluorine atoms.

16. The method of claim 15 wherein R_{f} is perfluorinated.

17. The method of claim 15 wherein said fluorinated compound is selected from the group consisting of n-C₃F₇OCH₃, (CF₃)₂CFOCH₃, n-C₄F₉OCH₃, (CF₃)₂CFCF₂OCH₃, n-C₃F₇OC₂H₅, n-C₄F₉OC₂H₅, (CF₃)₃COCH₃(CF₃)₂CFCF₂OC₂H₅, (CF₃)₃COC₂H₅, and mixtures thereof.

18. The method of claim 11 wherein said one or more organic agents are selected from the group consisting of alcohols, amides, lactams, amines, and sulfoxides.

19. The method of claim 18 wherein said organic agent is selected from the group consisting of methanol, ethanol, 1-propanol, isopropanol, 2-butanol, i-butanol, t-butanol, N,N-dimethylformamide, N-methylformamide, N,N-dimethyl acetamide, N,N-diethyl acetamide, N-methyl-2-pyrrolidone, imidazolidinoe, monoethanolamine, and dimethylsulfoxide.

20. The method of claim 11 wherein the weight ratio of said one or more fluorinated compound to said one or more organic solvents is from about 19:1 to about 1:1.

21. The method of claim 11 wherein said treating composition has less than 3 particles (of greater than 5.0 micron diameter) per milliliter, less that 5000 parts per trillion of metals, and less than 250 parts per trillion of non-volatile residues.

22. The method of claim 11 wherein said cleaning composition has a boiling point of less than 120° C.

23. The method of claim 11 wherein said cleaning composition has a surface tension of less than 20 dynes/cm.

24. The method of claim 11 wherein said substrate is selected from silicon wafers, silicon chips, polysilicon chips, GaAs wafers, integrated circuits and microelectromechanical devices.

25. The method of claim 11 further comprising the step of separating the processed substrate from said treating composition.

26. The method of claim 11 wherein said treating composition etches said substrate.

27. The method of claim 11 wherein said treating composition contacts said substrate for a time sufficient to achieve a predetermined degree of etching.

28. The method of claim 11 wherein said treating composition removes particulates from said substrate.

29. The method of claim 11 wherein said treating composition etches and releases microelectromechanical devices.

30. The method of claim 11 wherein substantially all of the fluoride ion present in said treating composition is resultant from the interaction of said fluorinated compounds with said organic agents.

31. The method of claim 11 wherein the temperature of said treating composition is between about 18° C. and about 80° during the time said composition is contacting said substrate.
